(19) United States
(12) Patent Application Publication
(10) Pub. No.: US 2024/0124058 A1
(43) Pub. Date: Apr. 18, 2024

(54) CORNER MODULE APPARATUS FOR VEHICLE

(71) Applicant: HYUNDAI MOBIS CO., LTD., Seoul (KR)

(72) Inventors: Jae Woong JEON, Yongin-si (KR); Jin Wook JOO, Yongin-si (KR)

(73) Assignee: HYUNDAI MOBIS CO., LTD., Seoul (KR)

(21) Appl. No.: 18/237,042

(22) Filed: Aug. 23, 2023

(30) Foreign Application Priority Data
Oct. 13, 2022 (KR) 10-2022-0131455
Nov. 2, 2022 (KR) 10-2022-0144536

(51) Int. Cl. B62D 7/15

(52) U.S. Cl. CPC B62D 7/1545

(57) ABSTRACT

A corner module apparatus may include: a drive unit configured to provide driving power to a wheel, a knuckle unit connected to the drive unit, a steering drive unit configured to generate a steering force while extending or contracting in a longitudinal direction, a steering angle adjustment unit connected to the knuckle unit, disposed so that a longitudinal direction thereof is different from the longitudinal direction of the steering drive unit, and configured to adjust a steering angle of the wheel in conjunction with the steering force generated from the steering drive unit, and a crank member disposed to be spaced apart from the steering drive unit in a height direction of the vehicle body and configured to convert a transmission direction of the steering force, which is generated from the steering drive unit, into the longitudinal direction of the steering angle adjustment unit.

### CROSS-REFERENCE TO RELATED APPLICATION

This application claims priority from and the benefit of Korean Patent Application No. 10-2022-0131455, filed on Oct. 13, 2022, and Korean Patent Application No. 10-2022-0144536, filed on Nov. 2, 2022, which are hereby incorporated by reference for all purposes as if set forth herein.

### BACKGROUND

### Technical Field

Exemplary embodiments of the present disclosure relate to a corner module apparatus for a vehicle, and more particularly, to a corner module apparatus for a vehicle, in which driving, braking, steering, suspension systems are integrated.

### Discussion of the Background

In general, an electric vehicle refers to an environmental-friendly vehicle that emits no exhaust gas. The electric vehicle is equipped with a high-voltage battery configured to supply energy to drive the electric vehicle, and a driving motor configured to generate a rotational force from electric power outputted from the high-voltage battery. The electric vehicle travels as rotational power of the motor is transmitted to a wheel through a driving shaft.

Recently, in-wheel motor vehicles have been in the limelight. In the in-wheel motor vehicle, intermediate power transmission devices, such as a speed reducer or a differential gear, may be excluded, which may reduce a weight of the vehicle. In the in-wheel motor vehicle, a motor is directly installed in a wheel in consideration of an advantage of reducing a loss of energy during a power transmission process, such that power of the motor is transmitted directly to the wheel. Furthermore, the development has also been actively conducted on a wheel in which braking, steering, suspension systems as well as a driving system are integrated.

The background technology of the present disclosure is disclosed in Korean Patent Application Laid-Open No. 10-2019-0041855 (published on Apr. 23, 2019 and entitled ‘Steering System for an In-Wheel Motor Vehicle).

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various embodiments are directed to a corner module apparatus for a vehicle, which is capable of independently controlling operations of wheels.

Various embodiments are also directed to a corner module apparatus for a vehicle, which is capable of easily ensuring an interior space of a vehicle.

In an embodiment, a corner module apparatus for a vehicle includes: a drive unit configured to provide driving power to a wheel; a knuckle unit connected to the drive unit; a steering drive unit configured to couple to a vehicle body and configured to generate a steering force while extending or contracting in a longitudinal direction of the steering drive unit; a steering angle adjustment unit connected to the knuckle unit, disposed so that a longitudinal direction of the steering angle adjustment unit is different from the longitudinal direction of the steering drive unit, and configured to adjust a steering angle of the wheel in conjunction with the steering force generated from the steering drive unit; and a crank member disposed to be spaced apart from the steering drive unit in a height direction of the vehicle body and configured to convert a transmission direction of the steering force, which is generated from the steering drive unit, into the longitudinal direction of the steering angle adjustment unit.

The steering drive unit may include: a power generation module configured to couple to the vehicle body and configured to generate driving power; a push rod configured to be extended or retracted in conjunction with the driving power of the power generation module; and a first joint extending from the push rod and rotatably connected to one side of the crank member.

The wheel may include front and rear wheels disposed to be spaced apart from each other in a longitudinal direction of the vehicle body, and the power generation module may be configured to be disposed between the front and rear wheels.

The push rod may be disposed so that a longitudinal direction of the push rod is parallel to a longitudinal direction of the vehicle.

The steering angle adjustment unit may include: a tie rod having one side and an other side opposing each other and face the crank member and the knuckle unit, respectively; a second joint at the one side of the tie rod and rotatably connected to the other side of the crank member; and a third joint at the other side of the tie rod and rotatably connected to the knuckle unit.

The second joint may be connected to the other side of the crank member so as to be rotatable about multiple axes.

The crank member may include: a crank body supported to be rotatable about an axis defined in the height direction of the vehicle body; a first extension part extending from the crank body and connected to the steering drive unit; and a second extension part extending from the crank body and connected to the steering angle adjustment unit.

The first and second extension parts may extend in different directions from the crank body.

A length of the first extension part may be shorter than a length of the second extension part.

When the steering drive unit performs an extension or contraction operation, the second extension part may rotate at the same angular velocity as the first extension part and apply a compressive or tensile load to the steering angle adjustment unit depending on a rotation direction.

In another embodiment, a corner module apparatus for a vehicle includes: a knuckle unit connected to a drive unit configured to provide driving power to a wheel; a steering drive unit disposed to be spaced apart from the knuckle unit and configured to generate a steering force; a steering angle adjustment unit connected to the knuckle unit and the steering drive unit and configured to adjust a steering angle of the wheel in conjunction with the steering force generated from the steering drive unit; and a power transmission unit between the steering drive unit and the steering angle adjustment unit and configured to amplify the steering force generated from the steering drive unit and transmit the steering force to the steering angle adjustment unit.

The steering drive unit may include a steering motor configured to couple to a vehicle body and configured to generate a rotational force.

The power transmission unit may include: a steering input shaft connected to the steering drive unit and configured to rotate by receiving the steering force from the steering drive unit; a steering output shaft connected to the steering angle adjustment unit and configured to rotate the steering angle adjustment unit in conjunction with a rotation of the steering input shaft; and a transmission gear unit between the steering input shaft and the steering output shaft and configured to allow transmission of a rotational force of the steering input shaft to the steering output shaft and block transmission of a rotational force of the steering output shaft to the steering input shaft.

The steering input shaft and the steering output shaft may be disposed in parallel with each other.

The transmission gear unit may include: a first transmission gear connected to the steering input shaft and configured to rotate in conjunction with the rotation of the steering input shaft; and a second transmission gear coupled by engaging with the first transmission gear and configured to rotate the steering output shaft in conjunction with a rotation of the first transmission gear.

The first transmission gear may include a worm gear, and the second transmission gear may include a worm wheel.

The steering angle adjustment unit may include: a first steering angle adjustment member connected to the power transmission unit and configured to rotate by receiving the steering force from the power transmission unit; and a second steering angle adjustment member connected to the first steering angle adjustment member and the knuckle unit and configured to adjust the steering angle of the wheel by converting a rotational motion of the first steering angle adjustment member into a straight reciprocating motion.

The first steering angle adjustment member and the second steering angle adjustment member may be disposed to be inclined with respect to each other.

The first steering angle adjustment member may include: a link body having one side and an other side opposing each other and face the power transmission unit and the second steering angle adjustment member, respectively; a first connection part disposed at the one side of the link body and connected to the power transmission unit; and a second connection part disposed at the other side of the link body and connected to the second steering angle adjustment member.

The link body may rotate about the first connection part and apply a compressive or tensile load to the second steering angle adjustment member depending on a rotation direction.

The second steering angle adjustment member may include: a tie rod having one side and an other side opposing each other and face the knuckle unit and the first steering angle adjustment member, respectively; a first joint disposed at the other side of the tie rod and configured to support the tie rod on the first steering angle adjustment member so that the tie rod is rotatable; and a second joint disposed at the one side of the tie rod and configured to support the tie rod on the knuckle unit so that the tie rod is rotatable.

The first and second joints may support the other side and the one side of the tie rod on the first steering angle adjustment member and the knuckle unit so that the other side and the one side of the tie rod are rotatable about multiple axes.

According to the corner module apparatus for a vehicle, the longitudinal direction of the steering drive unit is disposed in parallel with the longitudinal direction of the vehicle, such that the interior space of the vehicle may be easily ensured, and a degree of design freedom of a life module may be increased.

According to the corner module apparatus for a vehicle, the kingpin axis and the suspension axis may be respectively and separately disposed on the first knuckle and the second knuckle that face each other in the width direction of the vehicle. Therefore, the kingpin axis may be prevented from being excessively distant from the wheel, which makes it possible to reduce a kingpin offset value and improve traveling and braking stability of the vehicle.

According to the corner module apparatus for a vehicle, the crank member may allow the steering force to be smoothly transmitted through the steering drive unit and the steering angle adjustment unit disposed so that the longitudinal directions thereof are different from each other.

According to the corner module apparatus for a vehicle, the power generation module is disposed between the front wheel and the rear wheel, which may reduce a risk of damage to the power generation module in the event of a front or rear collision of the vehicle.

According to the corner module apparatus for a vehicle, the crank member and the steering drive unit are disposed to be spaced apart from each other in the height direction of the vehicle body, thereby improving the spatial utilization.

According to the corner module apparatus for a vehicle, the steering drive unit is coupled to and supported on the vehicle body, and a magnitude of unsprung mass applied to the suspension unit may be reduced, thereby further improving the ground contact performance of the vehicle.

According to the corner module apparatus for a vehicle, the kingpin axis and the suspension axis may be respectively and separately disposed on the first knuckle and the second knuckle that face each other in the width direction of the vehicle. Therefore, the kingpin axis may be prevented from being excessively distant from the wheel, which makes it possible to reduce a kingpin offset value and improve traveling and braking stability of the vehicle.

According to the corner module apparatus for a vehicle, the first steering angle adjustment member and the second steering angle adjustment member are disposed to be inclined with respect to each other, which may easily ensure the interior space of the vehicle and increase a degree of design freedom of the life module.

According to the corner module apparatus for a vehicle, the transmission gear unit prevents the steering angle adjustment unit from being reversely rotated by a reaction force reversely inputted through the wheel from the road surface at the time of steering the wheel, thereby improving the traveling and manipulating stability of the vehicle.

### BRIEF DESCRIPTION OF THE DRAWINGS

FIG. 1 is an installed state view schematically illustrating a configuration of a corner module apparatus for a vehicle according to a first embodiment of the present disclosure.

FIG. 2 is a perspective view schematically illustrating the configuration of the corner module apparatus for a vehicle according to the first embodiment of the present disclosure.

FIG. 3 is a top plan view schematically illustrating the configuration of the corner module apparatus for a vehicle according to the first embodiment of the present disclosure.

FIG. 4 is a front view schematically illustrating the configuration of the corner module apparatus for a vehicle according to the first embodiment of the present disclosure.

FIG. 5 is a side view schematically illustrating the configuration of the corner module apparatus for a vehicle according to the first embodiment of the present disclosure.

FIG. 6 is an exploded perspective view schematically illustrating the configuration of the corner module apparatus for a vehicle according to the first embodiment of the present disclosure.

FIG. 7 is an enlarged view schematically illustrating configurations of a steering drive unit, a steering angle adjustment unit, and a crank member according to the first embodiment of the present disclosure.

FIGS. 8 and 9 are operational views schematically illustrating an operation of the corner module apparatus for a vehicle according to the first embodiment of the present disclosure that adjusts a steering angle of a wheel.

FIG. 10 is a perspective view schematically illustrating a configuration of a corner module apparatus for a vehicle according to a second embodiment of the present disclosure.

FIG. 11 is a top plan view schematically illustrating the configuration of the corner module apparatus for a vehicle according to the second embodiment of the present disclosure.

FIG. 12 is a front view schematically illustrating the configuration of the corner module apparatus for a vehicle according to the second embodiment of the present disclosure.

FIG. 13 is a side view schematically illustrating the configuration of the corner module apparatus for a vehicle according to the second embodiment of the present disclosure.

FIG. 14 is an exploded perspective view schematically illustrating the configuration of the corner module apparatus for a vehicle according to the second embodiment of the present disclosure.

FIG. 15 is an enlarged view schematically illustrating a configuration of a steering angle adjustment unit according to the second embodiment of the present disclosure.

FIG. 16 is a perspective view schematically illustrating a configuration of a power transmission unit according to the second embodiment of the present disclosure.

FIG. 17 is a cross-sectional view schematically illustrating the configuration of the power transmission unit according to the second embodiment of the present disclosure.

FIGS. 18 and 19 are operational views schematically illustrating an operation of the corner module apparatus for a vehicle according to the second embodiment of the present disclosure that adjusts a steering angle of a wheel.

### DETAILED DESCRIPTION OF THE ILLUSTRATED EMBODIMENTS

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Advantages and features of the present disclosure and methods of achieving the advantages and features will be clear with reference to embodiments described in detail below together with the accompanying drawings. However, the present disclosure is not limited to the embodiments disclosed herein but will be implemented in various forms. The embodiments of the present disclosure are provided so that the present disclosure is completely disclosed, and a person with ordinary skill in the art can fully understand the scope of the present disclosure. The present disclosure will be defined only by the scope of the appended claims. Meanwhile, the terms used in the present specification are for explaining the embodiments, not for limiting the present disclosure.

Terms, such as first, second, A, B, (a), (b) or the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

Throughout the specification, when a component is described as being “connected to,” or “coupled to” another component, it may be directly “connected to,” or “coupled to” the other component, or there may be one or more other components intervening therebetween. In contrast, when an element is described as being “directly connected to,” or “directly coupled to” another element, there can be no other elements intervening therebetween.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Hereinafter, a corner module apparatus for a vehicle will be described below with reference to the accompanying drawings through various exemplary embodiments.

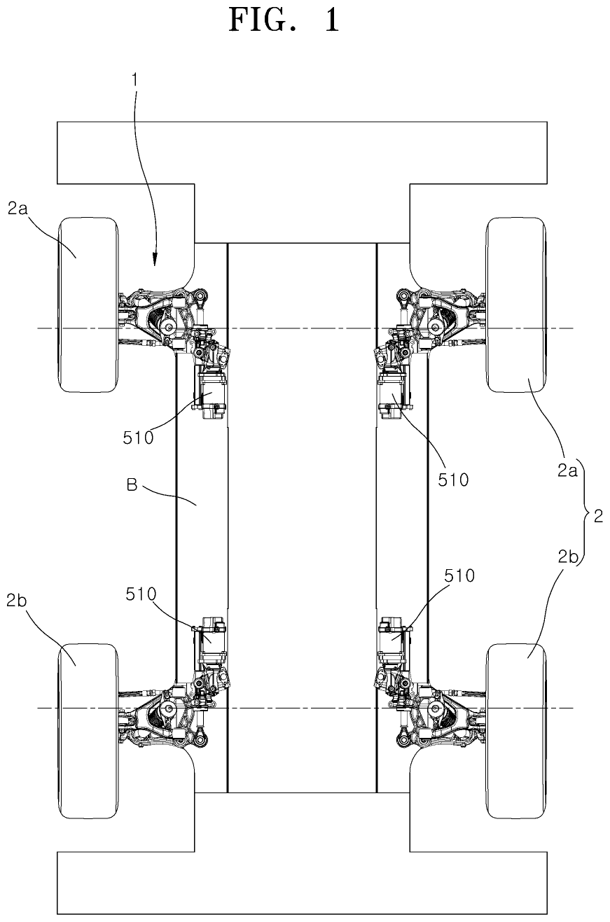

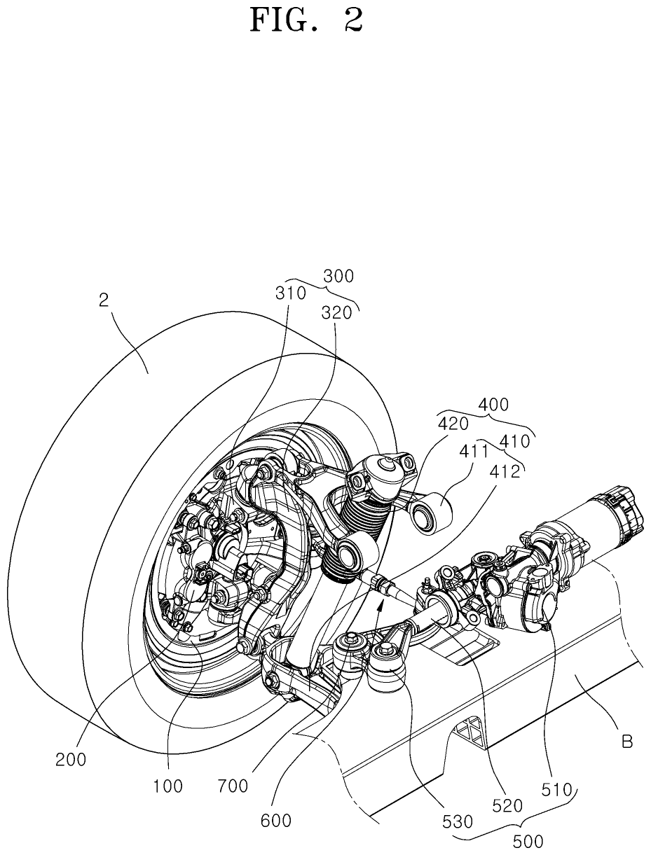

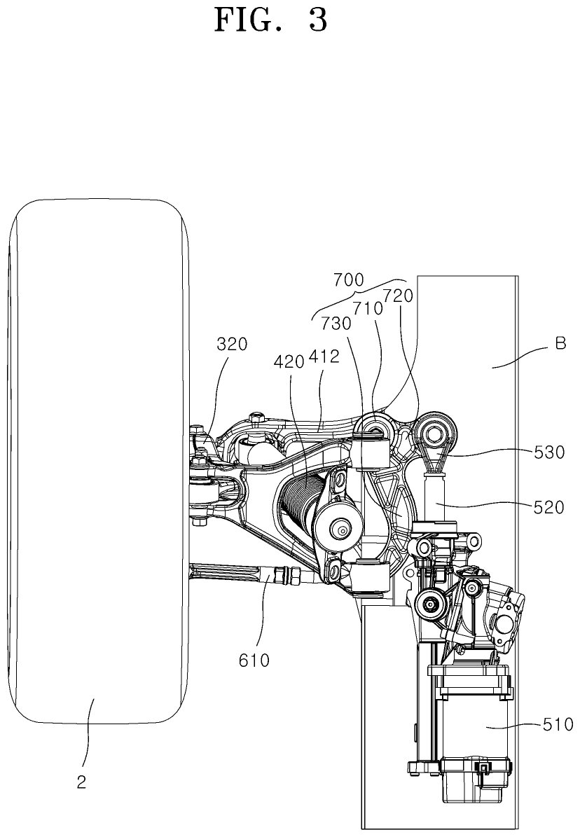

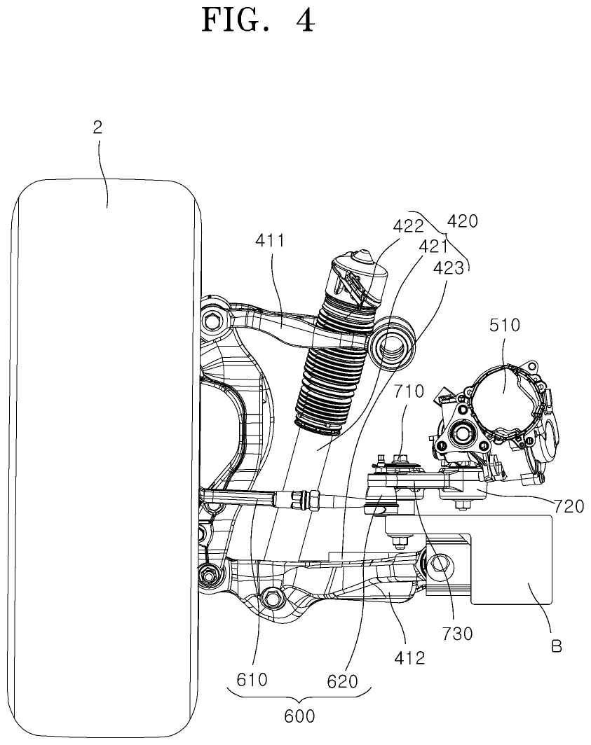

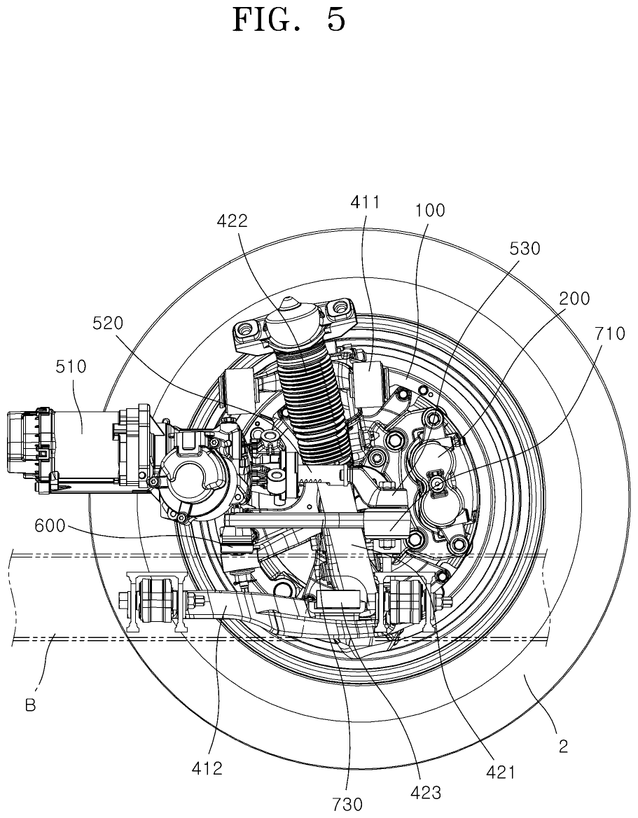

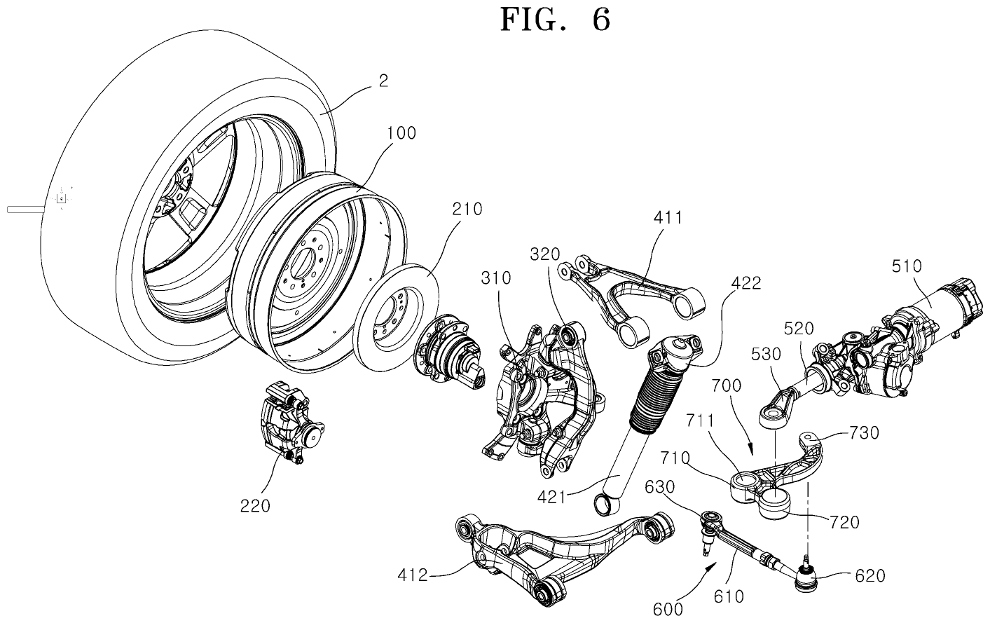

FIG. 1 is an installed state view schematically illustrating a configuration of a corner module apparatus for a vehicle according to a first embodiment of the present disclosure, FIG. 2 is a perspective view schematically illustrating the configuration of the corner module apparatus for a vehicle according to the first embodiment of the present disclosure, FIG. 3 is a top plan view schematically illustrating the configuration of the corner module apparatus for a vehicle according to the first embodiment of the present disclosure, FIG. 4 is a front view schematically illustrating the configuration of the corner module apparatus for a vehicle according to the first embodiment of the present disclosure, FIG. 5 is a side view schematically illustrating the configuration of the corner module apparatus for a vehicle according to the first embodiment of the present disclosure, and FIG. 6 is an exploded perspective view schematically illustrating the configuration of the corner module apparatus for a vehicle according to the first embodiment of the present disclosure.

With reference to FIGS. 1 to 6, a corner module apparatus 1 for a vehicle according to a first embodiment of the present disclosure includes a drive unit 100, a knuckle unit 300, a steering drive unit 500, a steering angle adjustment unit 600, and a crank member 700.

The drive units 100 are installed inside wheels 2 of the vehicle and rotate the wheels 2 by providing driving power to the wheels 2. The wheels 2 may include a pair of front wheels 2a and a pair of rear wheels 2b that are spaced apart from one another in a longitudinal direction of the vehicle. The drive unit 100 may be provided as a plurality of drive units 100. The plurality of drive units 100 is respectively installed in the pair of front wheels 2a and the pair of rear wheels 2b and independently provides driving power to the pair of front wheels 2a and the pair of rear wheels 2b. The wheel 2 to be described below may be exemplified as any one of the pair of front wheels 2a and the pair of rear wheels 2b.

The drive unit 100 may include a stator fixed inside the wheel 2 and configured to form a magnetic field by receiving electric power from a battery of the vehicle, and a rotor rotatably installed inside the wheel 2 and configured to rotate the wheel 2 by means of an electromagnetic interaction with the stator. The stator and the rotor have central axes positioned on the same line as a central axis of the wheel 2. The stator and the rotor may be disposed inside the wheel 2 and stacked on each other on a concentric circle.

The braking unit 200 may be installed inside the wheel 2 and apply a braking force or cut off the application of the braking force while interfering with the rotation of the wheel 2.

The braking unit 200 may include a brake disc 210 and a brake caliper 220.

The brake disc 210 is connected to the wheel 2 or the drive unit 100 and rotates in conjunction with the rotation of the wheel 2. The brake disc 210 may have a circular plate shape and be installed inside the wheel 2. The brake disc 210 may be disposed so that a central axis thereof is positioned on the same line as the central axis of the wheel 2. The brake disc 210 may be integrally connected to the wheel 2 or the rotor of the drive unit 100 by bolting or the like. Therefore, when the wheel 2 rotates, the brake disc 210 may rotate about the central axis together with the wheel 2. A diameter of the brake disc 210 may be variously designed and modified based on a diameter of the wheel 2, a size of the drive unit 100, or the like.

The brake caliper 220 applies the braking force by pressing the brake disc 210 at the time of braking the vehicle. The brake caliper 220 may include a brake pad disposed to face the brake disc 210, a caliper housing coupled to the knuckle unit 300 and configured to support the brake pad so that the brake pad is movable, and a piston installed in the caliper housing and configured to be extended or retracted, the piston being configured to press the brake pad toward the brake disc 210 or release the brake pad depending on a movement direction.

The knuckle unit 300 is coupled to the drive unit 100 and serves as a configuration for providing the mechanical connection of the suspension unit 400 and the steering angle adjustment unit 600 to the wheel 2.

The knuckle unit 300 may include a first knuckle 310 and a second knuckle 320.

The first knuckle 310 is coupled to the drive unit 100 and serves as a configuration for defining a kingpin axis, which is a steering center axis, by providing the mechanical connection of the steering angle adjustment unit 600 to the wheel 2.

The first knuckle 310 may be coupled to and supported on the stator of the drive unit 100 by bolting or the like. The first knuckle 310 may support the rotor of the drive unit 100 by means of a wheel bearing so that the rotor is rotatable. The first knuckle 310 may be manufactured by forming a metallic material by casting or the like in order to ensure sufficient rigidity. The specific shape of the first knuckle 310 is not limited to the shape illustrated in the drawings. The shape of the first knuckle 310 may be variously designed and modified within the technical spirit as long as the first knuckle 310 is coupled to the drive unit 100 and disposed to face an inner surface of the wheel 2.

The second knuckle 320 is connected to the first knuckle 310 and serves as a configuration for providing the mechanical connection of the suspension unit 400, which will be described below, to the wheel 2 and defining a suspension axis along which the wheel 2 moves upward or downward when the wheel 2 performs a bump and rebound motion.

The second knuckle 320 may be disposed to face the first knuckle 310 in a width direction of the vehicle. Two opposite upper and lower ends of the second knuckle 320 may be connected to the first knuckle 310 by means of ball joints. Therefore, the first knuckle 310 and the second knuckle 320 may separate, in the width direction of the vehicle, the suspension axis defined on the second knuckle 320 and the kingpin axis defined on the first knuckle 310 so that the kingpin axis is disposed at a position adjacent to the wheel 2, such that a kingpin offset value may be decreased, and the traveling and braking stability of the vehicle may be improved.

The suspension unit 400 may be connected to the knuckle unit 300, more specifically, the second knuckle 320 and support the knuckle unit 300 on a vehicle body B. The suspension unit 400 may be provided to absorb impact transmitted from a road surface through the wheel 2 when the vehicle travels. In this case, the vehicle body B may be exemplified as a chassis frame such as a sub-frame (not illustrated) installed at a lower side of the vehicle.

The suspension unit 400 may include a suspension arm 410 and a shock absorber 420.

The suspension arm 410 is provided between the second knuckle 320 and the vehicle body B and supports the second knuckle 320. More specifically, the suspension arm 410 may connect the wheel 2 to the vehicle body by means of the second knuckle 320 and absorb a load applied from the wheel 2 by using rigidity thereof while the vehicle travels. Further, the suspension arm 410 may serve to adjust a motion of the wheel 2.

The suspension arm 410 may include a first arm 411 and a second arm 412.

One end of the first arm 411 and one end of the second arm 412 are rotatably connected to the second knuckle 320, and the other end of the first arm 411 and the other end of the second arm 412 are rotatably connected to the vehicle body. In this case, two opposite ends of each of the first arm 411 and the second arm 412 may be respectively rotatably supported on the second knuckle 320 and the vehicle body by means of bushings, ball joints, pins, or the like. The first arm 411 and the second arm 412 may be disposed to face each other and be spaced apart from each other in an upward/downward direction. That is, one end of the first arm 411 and one end of the second arm 412 may be respectively connected to upper and lower ends of the second knuckle 320. The first arm 411 and the second arm 412 may each be formed to have a double wishbone shape. Therefore, the first arm 411 and the second arm 412 may set a negative camber of the wheel 2, which makes it possible to improve the cornering performance of the vehicle and set a low-height structure for reducing a vehicle height.

The shock absorber 420 is provided to be extendable and contractible in a longitudinal direction and absorbs impact or vibration transmitted to the vehicle body through the wheel 2 from the road surface.

The shock absorber 420 may include a cylinder 421, a rod 422, and an elastic body 423.

The cylinder 421 may extend in the upward/downward direction, and the interior of the cylinder 421 may be filled with a fluid. A lower end of the cylinder 421 may penetrate the first arm 411 and be rotatably connected to an upper surface of the second arm 412.

The rod 422 may extend in a longitudinal direction of the cylinder 421. A lower side of the rod 422 may be inserted into an upper end of the cylinder 421 and installed to be slidable in the longitudinal direction of the cylinder 421. An upper side of the rod 422 is coupled to a wheel housing (not illustrated) or the like. The rod 422 may slide in the longitudinal direction of the cylinder 421 when the wheel 2 performs a bump or rebound motion.

The elastic body 423 may be provided in the form of a flat spring having a longitudinal direction extending in a direction parallel to the width direction of the vehicle body B. A lower surface of the elastic body 423 may be seated on and supported on an upper surface of the second arm 412. One end of the elastic body 423 may be fixed to the vehicle body B by welding, bolting, or the like. When the second arm 412 is rotated by a bump or rebound motion of the wheel 2, the elastic body 423 may be elastically deformed in the upward/downward direction, thereby cancelling out impact applied from the road surface.

The steering drive unit 500 is coupled to the vehicle body B and generates a steering force while extending or contracting in a longitudinal direction. The steering drive unit 500 may be disposed such that the longitudinal direction of the steering drive unit 500, i.e., the extension/contraction direction is parallel to the longitudinal direction of the vehicle body B. In this case, the longitudinal direction and the width direction of the vehicle body B may each be exemplified as directions parallel to the longitudinal direction and the width direction of the vehicle. Therefore, the interior space of the vehicle may be easily ensured and a degree of design freedom of a life module may be increased in comparison with a case in which the steering drive unit 500 is disposed so that the longitudinal direction thereof is parallel to the width direction of the vehicle body B.

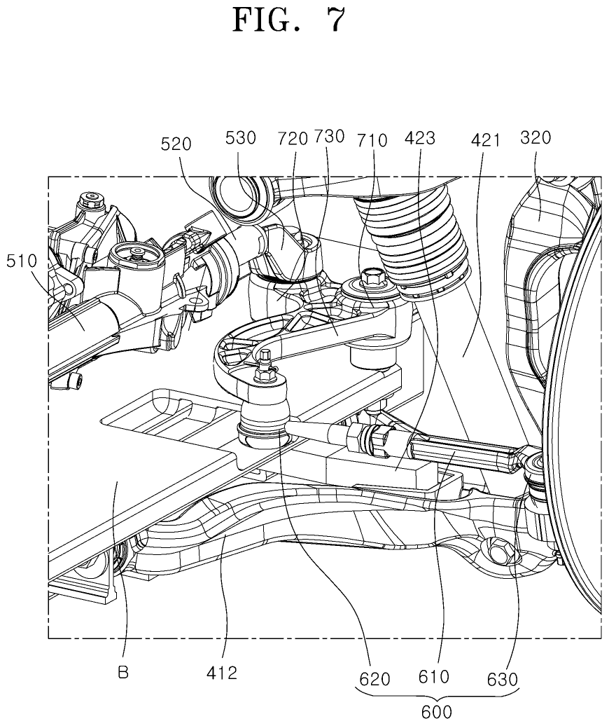

FIG. 7 is an enlarged view schematically illustrating configurations of the steering drive unit, the steering angle adjustment unit, and the crank member according to the first embodiment of the present disclosure.

With reference to FIGS. 1 to 7, the steering drive unit 500 may include a power generation module 510, a push rod 520, and a first joint 530.

The power generation module 510 is coupled to the vehicle body B and generates driving power by receiving electric power. The power generation module 510 may be exemplified as various types of electric motors that generate rotational forces from electric power applied from the outside. The power generation module 510 may be provided to have a hollow rotary shaft. The power generation module 510 may be connected to the battery of the vehicle and supplied with electric power from the battery. The power generation module 510 may be connected to an ECU or the like of the vehicle. Whether a rotational force is generated, a direction of the rotational force, or the like may be controlled in response to a control signal of the ECU.

The power generation module 510 may be disposed between the front wheel 2a and the rear wheel 2b. That is, as illustrated in FIG. 1, the power generation module 510 may be disposed in a section defined between central axes of the front and rear wheels 2a and 2b with respect to the longitudinal direction of the vehicle body B. Therefore, it is possible to reduce a risk of damage to the power generation module 510 in the event of a front or rear collision of the vehicle.

The push rod 520 is connected to the power generation module 510 and extended or retracted in the longitudinal direction of the vehicle body B in conjunction with the driving power generated from the power generation module 510. The push rod 520 may be formed to have an approximately rod shape, and one side of the push rod 520 may be inserted into the power generation module 510. The push rod 520 may be disposed so that a longitudinal direction thereof is parallel to the longitudinal direction of the vehicle body B. One side of the push rod 520 may be connected to the rotary shaft of the power generation module 510. In this case, one side of the push rod 520 may be connected to the rotary shaft of the power generation module 510 by screw coupling, ball screw coupled, rack-and-pinion coupled, or the like. Therefore, the push rod 520 converts a rotational motion of the rotary shaft of the power generation module 510 into a rectilinear motion and reciprocates straight in the longitudinal direction of the vehicle body B.

The first joint 530 extends from the push rod 520 and is rotatably connected to one side of the crank member 700. The first joint 530 may extend from the other end of the push rod 520 positioned to be opposite to the power generation module 510. The first joint 530 may be integrally connected to the push rod 520 by welding or the like. Alternatively, the first joint 530 may be detachably coupled to the push rod 520 by bolting or the like. An end of the first joint 530 may be connected to an end of a first extension part 720 of the crank member 700 to be described below. The first joint 530 may apply a rotational force to the crank member 700 clockwise or counterclockwise while reciprocating together with the push rod 520 when the push rod 520 is extended or retracted.

The end of the first joint 530 may be connected to the end of the first extension part 720 of the crank member 700 to be described below so that the first joint 530 is rotatable about multiple axes. In this case, the first joint 530 may include various types of connection means such as ball joints, bushing joints, or the like that may be connected to the first extension part 720 so as to be rotatable about multiple axes. Therefore, the first joint 530 may allow a rectilinear motion of the push rod 520 to be smoothly converted into a rotational motion of the crank member 700.

The steering angle adjustment unit 600 is connected to the knuckle unit 300, more specifically, the first knuckle 310 and adjusts a steering angle of the wheel 2 in conjunction with a steering force generated from the steering drive unit 500. More specifically, the steering angle adjustment unit 600 adjusts the steering angle of the wheel 2 by receiving, through the crank member 700 to be described below, the steering force generated from the steering drive unit 500. The steering angle adjustment unit 600 is disposed so that a longitudinal direction thereof is different from the longitudinal direction of the steering drive unit 500. For example, in case that the wheel 2 is positioned at a neutral position, the steering angle adjustment unit 600 may be disposed so that the longitudinal direction thereof is parallel to the width direction of the vehicle based on FIG. 1.

The steering angle adjustment unit 600 may include a tie rod 610, a second joint 620, and a third joint 630.

The tie rod 610 defines a schematic external appearance of the steering angle adjustment unit 600 and supports the second joint 620 and the third joint 630 as a whole. The tie rod 610 may be provided in the form of a rod disposed so that two opposite sides thereof respectively face the other side of the crank member 700 and the first knuckle 310. The tie rod 610 may be disposed so that the longitudinal direction thereof is parallel to the width direction of the vehicle. The tie rod 610 may transmit the steering force, which is generated from the steering drive unit 500, to the wheel 2 while being moved by a tensile or compressive load transmitted from the crank member 700 connected by means of the second joint 620 to be described below.

The second joint 620 is provided at one side of the tie rod 610 and rotatably connected to the other side of the crank member 700. The second joint 620 may be disposed at one end of the tie rod 610 that faces the crank member 700. The second joint 620 may be integrally coupled to the tie rod 610 by welding or the like. Alternatively, the second joint 620 may be detachably coupled to the tie rod 610 by bolting or the like. The second joint 620 is connected to the other side of the crank member 700, more specifically, a second extension part 730. When the crank member 700 is rotated by the steering drive unit 500, the second joint 620 may apply a tensile or compressive load to the tie rod 610 while moving together with the second extension part 730.

The second joint 620 may be connected to the second extension part 730 so that the second joint 620 is rotatable about multiple axes. In this case, the second joint 620 may include various types of connection means such as ball joints, bushing joints, or the like that may be connected to the second extension part 730 so as to be rotatable about multiple axes. Therefore, the second joint 620 may allow the steering force, which is transmitted in the form of a tensile or compressive load by a rotation of the crank member 700, to be applied in the longitudinal direction of the tie rod 610. At the same time, the second joint 620 may allow the tie rod 610 to perform a suspension motion while changing an installation angle of the tie rod 610 upward or downward with respect to the crank member 700 when the wheel 2 performs a bump and rebound motion.

The third joint 630 is provided at the other side of the tie rod 610 and rotatably connected to the knuckle unit 300. The third joint 630 may be disposed at the other end of the tie rod 610 that faces the first knuckle 310. The third joint 630 may be integrally coupled to the tie rod 610 by welding or the like. Alternatively, the third joint 630 may be detachably coupled to the tie rod 610 by bolting or the like. The third joint 630 is rotatably connected to the first knuckle 310. When the tie rod 610 is reciprocated by the crank member 700, the third joint 630 may apply a tensile or compressive load to the first knuckle 310 while moving together with the tie rod 610.

The third joint 630 is connected to the first knuckle 310 at a position spaced apart from the central axis of the wheel 2 at a predetermined interval in a radial direction of the wheel 2. Therefore, the third joint 630 may allow a rotational moment of force for generating the steering angle to be applied to the wheel 2 when the tie rod 610 reciprocates straight.

The third joint 630 may be connected to the first knuckle 310 so that the third joint 630 is rotatable about multiple axes. In this case, the third joint 630 may include various types of connection means such as ball joints, bushing joints, or the like that may be connected to the first knuckle 310 so as to be rotatable along multiple axes. Therefore, the third joint 630 supports the wheel 2 so that the wheel 2 is rotatable relative to the tie rod 610 about an axis defined in a height direction of the vehicle, thereby inducing a smooth turning operation of the wheel 2. At the same time, the third joint 630 may allow the tie rod 610 to perform the suspension motion while changing the installation angle of the tie rod 610 upward or downward with respect to the wheel 2 when the wheel 2 performs a bump and rebound motion.

The crank member 700 is provided between the steering drive unit 500 and the steering angle adjustment unit 600 and converts a transmission direction of the steering force, which is generated from the steering drive unit 500, into a longitudinal direction of the steering angle adjustment unit 600. More specifically, the crank member 700 may serve as a configuration for converting the transmission direction of the steering force, which is transmitted in the longitudinal direction of the steering drive unit 500, into the longitudinal direction of the steering angle adjustment unit 600. Therefore, the crank member 700 may allow the steering force to be smoothly transmitted through the steering drive unit 500 and the steering angle adjustment unit 600 disposed so that the longitudinal directions thereof are different from each other.

The crank member 700 may be disposed to be spaced apart from the steering drive unit 500 in the height direction of the vehicle body B. That is, as illustrated in FIGS. 4 and 5, the steering drive unit 500 and the crank member 700 may be disposed to be stacked upward and downward in the height direction of the vehicle body B. Therefore, the operation of the steering drive unit 500 and the operation of the crank member 700 may not interfere with each other, and the spatial utilization may be improved.

The crank member 700 may include a crank body 710, the first extension part 720, and the second extension part 730.

The crank body 710 defines an external appearance of a central portion of the crank member 700 and is supported to be rotatable about the axis defined in the height direction of the vehicle. The crank body 710 is disposed at a lower side of the steering drive unit 500 and spaced apart from the steering drive unit 500 at a predetermined interval. The crank body 710 may have a support hole 711 formed vertically through the crank body 710 in the height direction of the vehicle body B, i.e., the upward/downward direction. A separate support shaft (not illustrated) extending from the vehicle body is inserted into the support hole 711, such that the crank body 710 may be supported to be rotatable about the support hole 711 relative to the vehicle body B.

The first extension part 720 and the second extension part 730 extend toward two opposite sides from the crank body 710 and define external appearances of two opposite ends of the crank member 700. The first extension part 720 and the second extension part 730 may be respectively connected to the first joint 530 of the steering drive unit 500 and the second joint 620 of the steering angle adjustment unit 600. The first extension part 720 and the second extension part 730 may extend in different directions from the crank body 710 and disposed to define a predetermined angle. For example, the first extension part 720 and the second extension part 730 may be disposed at an angle of 90 degrees, such that the crank member 700 may be formed to have a cross-sectional shape having an approximately “¬” shape.

When the steering drive unit 500, i.e., the push rod 520 performs the extension and contraction operations, the first extension part 720 receives the steering force through the first joint 530 and rotates clockwise or counterclockwise about the support hole 711. The second extension part 730 may rotate at the same angular velocity as the first extension part 720 and apply a compressive or tensile load to the steering angle adjustment unit 600, i.e., the tie rod 610 through the second joint 620 depending on the rotation direction.

The first extension part 720 and the second extension part 730 may extend from the crank body 710 so as to have different lengths. For example, a length of the first extension part 720 may be shorter than a length of the second extension part 730. In this case, the lengths of the first and second extension parts 720 and 730 may be set at a ratio of about 1:2.5. Therefore, the second extension part 730 may have a larger rotation radius than the first extension part 720, such that a movement amount of the tie rod 610 may be increased compared to a movement amount of the push rod 520, and an installation space for the steering drive unit 500 may be reduced.

Hereinafter, an operation of the corner module apparatus 1 for a vehicle according to the first embodiment of the present disclosure will be described in detail.

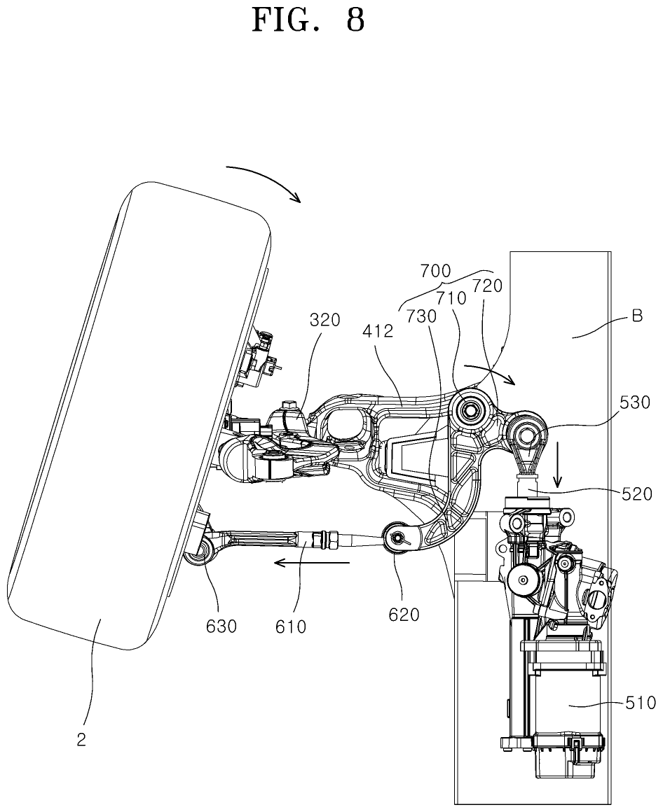

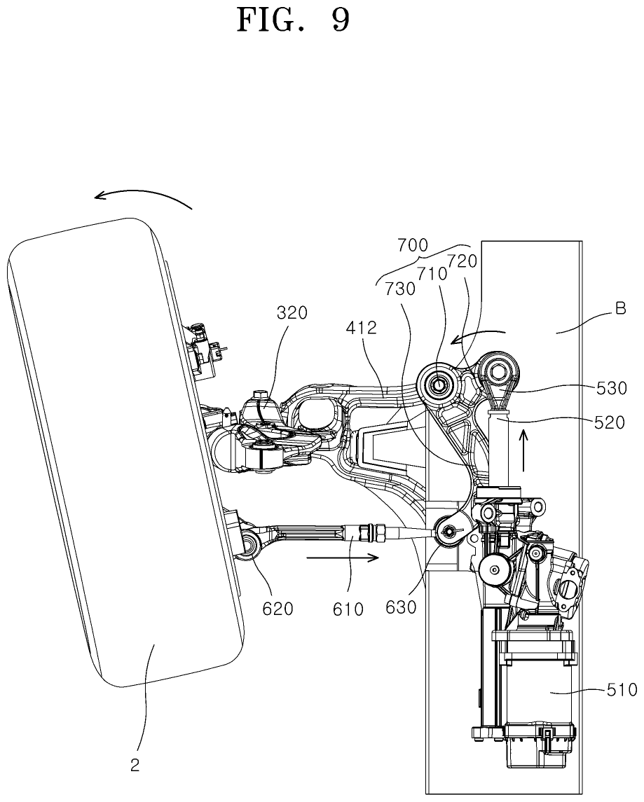

FIGS. 8 and 9 are operational views schematically illustrating an operation of the corner module apparatus for a vehicle according to the first embodiment of the present disclosure that adjusts the steering angle of the wheel.

With reference to FIG. 8, at the time of steering the vehicle rightward, the power generation module 510 retracts the push rod 520 (based on FIG. 8) by generating a rotational force in one direction.

When the push rod 520 is retracted, the first joint 530 connected to the other side of the push rod 520 is also retracted and rotates the first extension part 720 clockwise (based on FIG. 8). In this case, the rectilinear motion of the push rod 520 may be smoothly converted into the rotational motion of the first extension part 720 by the rotational operation of the first joint 530.

The second extension part 730 applies a compressive load to the tie rod 610 in the longitudinal direction while rotating clockwise at the same angular velocity as the first extension part 720.

The tie rod 610 is rectilinearly moved outward in the width direction of the vehicle by the compressive load. The rotational motion of the second extension part 730 may be smoothly converted into the rectilinear motion of the tie rod 610 by the rotational operation of the second joint 620.

When the tie rod 610 rectilinearly moves outward in the width direction of the vehicle, the third joint 630 finally presses the first knuckle 310 and rotates the wheel 2 rightward. The rectilinear motion of the tie rod 610 may be smoothly converted into the rotational motion of the wheel 2 by the rotational operation of the third joint 630.

In this case, the tie rod 610 may rectilinearly move while an installation angle thereof is changed by a change in position of the second joint 620 caused by a change in steering angle of the wheel 2.

With reference to FIG. 9, at the time of steering the vehicle leftward, the power generation module 510 moves the push rod 520 forward (based on FIG. 9) by generating a rotational force in the other direction.

When the push rod 520 is extended, the first joint 530 connected to the other side of the push rod 520 is also extended and rotates the first extension part 720 counterclockwise (based on FIG. 9).

The second extension part 730 applies a tensile load in the longitudinal direction of the tie rod 610 while rotating counterclockwise at the same angular velocity as the first extension part 720.

The tie rod 610 is rectilinearly moved inward in the width direction of the vehicle by the tensile load.

When the tie rod 610 rectilinearly moves inward in the width direction of the vehicle, the third joint 630 finally pulls the first knuckle 310 and rotates the wheel 2 leftward.

Hereinafter, a corner module apparatus 1′ for a vehicle according to a second embodiment of the present disclosure will be described.

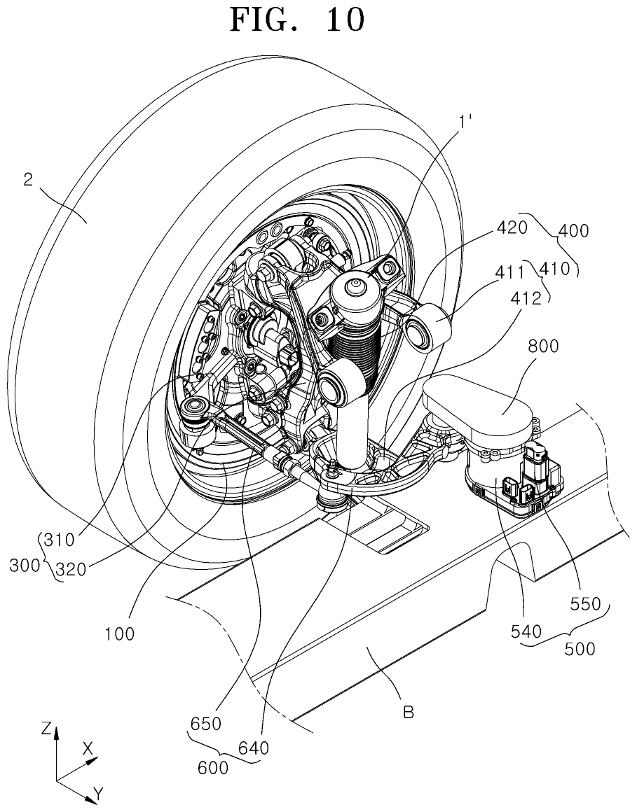

An example will be described in which the longitudinal direction, the width direction, and the height direction of the vehicle or the vehicle body B, which will be described below, are respectively directions parallel to X-axis, Y-axis, and Z-axis directions based on FIG. 10.

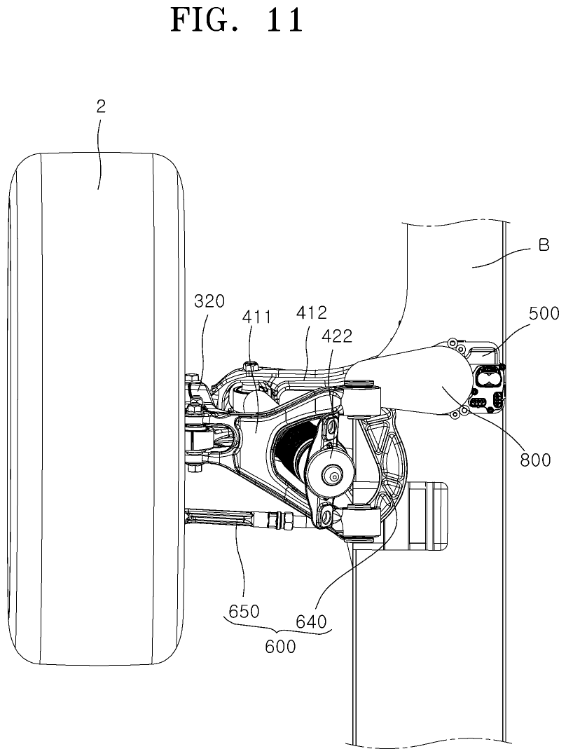

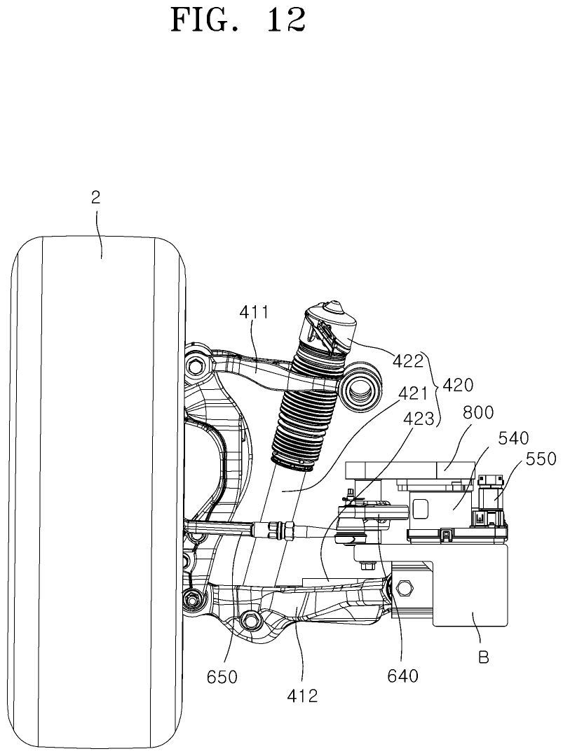

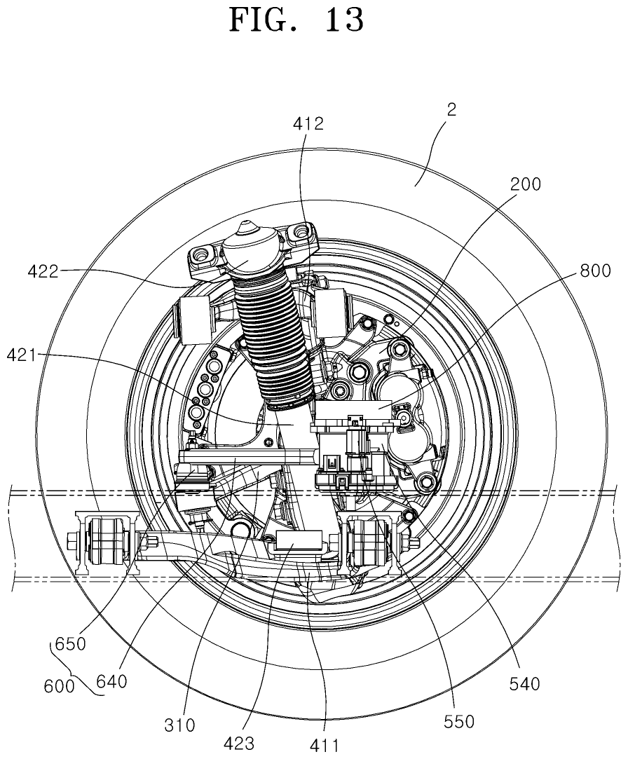

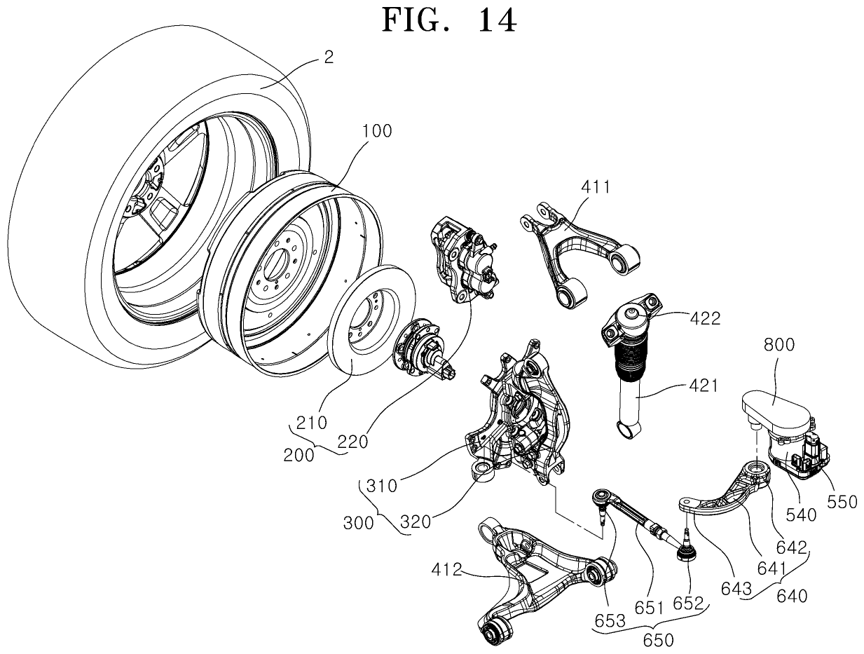

With reference to FIGS. 10 to 14, the corner module apparatus 1 for a vehicle according to the present embodiment may include the drive unit 100, the knuckle unit 300, the steering drive unit 500, the steering angle adjustment unit 600, and a power transmission unit 800.

The drive units 100 are installed inside the wheels 2 of the vehicle and rotate the wheels 2 by providing driving power to the wheels 2.

The drive unit 100 may be exemplified as various types of in-wheel motors each including the stator fixed inside the wheel 2 and configured to form a magnetic field by receiving electric power from a battery of the vehicle, and the rotor rotatably installed inside the wheel 2 and configured to rotate the wheel 2 by means of an electromagnetic interaction with the stator. The stator and the rotor have central axes positioned on the same line as a central axis of the wheel 2. The stator and the rotor may be disposed inside the wheel 2 and stacked on each other on a concentric circle.

The braking unit 200 may be installed inside the wheel 2 and apply a braking force or cut off the application of the braking force while interfering with the rotation of the wheel 2.

The braking unit 200 may include the brake disc 210 and the brake caliper 220.

The brake disc 210 is connected to the wheel 2 or the drive unit 100 and rotates in conjunction with the rotation of the wheel 2. The brake disc 210 may have a circular plate shape and is installed inside the wheel 2. The brake disc 210 may be disposed so that a central axis thereof is positioned on the same line as the central axis of the wheel 2. The brake disc 210 may be integrally connected to the wheel 2 or the rotor of the drive unit 100 by bolting or the like. Therefore, when the wheel 2 rotates, the brake disc 210 may rotate about the central axis together with the wheel 2. A diameter of the brake disc 210 may be variously designed and modified based on a diameter of the wheel 2, a size of the drive unit 100, or the like.

The brake caliper 220 applies the braking force by pressing the brake disc 210 at the time of braking the vehicle. The brake caliper 220 may include the brake pad disposed to face the brake disc 210, the caliper housing coupled to the knuckle unit 300 and configured to support the brake pad so that the brake pad is movable, and the piston installed in the caliper housing and configured to be extended or retracted, the piston being configured to press the brake pad toward the brake disc 210 or release the brake pad depending on a movement direction.

The knuckle unit 300 is coupled to the drive unit 100 and serves as a configuration for providing the mechanical connection of the suspension unit 400 and the steering angle adjustment unit 600 to the wheel 2.

The knuckle unit 300 may include the first knuckle 310 and the second knuckle 320.

The first knuckle 310 is coupled to the drive unit 100 and serves as a configuration for defining the kingpin axis, which is the steering center axis, by providing the mechanical connection of the steering angle adjustment unit 600 to the wheel 2. The first knuckle 310 may be coupled to and supported on the stator of the drive unit 100 by bolting or the like. The first knuckle 310 may support the rotor of the drive unit 100 by means of a wheel bearing so that the rotor is rotatable. The first knuckle 310 may be manufactured by forming a metallic material by casting or the like in order to ensure sufficient rigidity. The specific shape of the first knuckle 310 is not limited to the shape illustrated in the drawings. The shape of the first knuckle 310 may be variously designed and modified within the technical spirit as long as the first knuckle 310 is coupled to the drive unit 100 and disposed to face an inner surface of the wheel 2.

The second knuckle 320 is connected to the first knuckle 310 and serves as a configuration for providing the mechanical connection of the suspension unit 400 to the wheel 2 and defining the suspension axis along which the wheel 2 moves upward or downward when the wheel 2 performs a bump and rebound motion. The second knuckle 320 may be disposed to face the first knuckle 310 in the width direction of the vehicle. Two opposite upper and lower ends of the second knuckle 320 may be connected to the first knuckle 310 by means of ball joints. Therefore, the first knuckle 310 and the second knuckle 320 may be separated from, in the width direction of the vehicle, the suspension axis defined on the second knuckle 320 and the kingpin axis defined on the first knuckle 310 so that the kingpin axis is disposed at a position adjacent to the wheel 2, such that a kingpin offset value may be decreased, and the traveling and braking stability of the vehicle may be improved.

The suspension unit 400 may be connected to the knuckle unit 300, more specifically, the second knuckle 320 and support the knuckle unit 300 on the vehicle body. The suspension unit 400 is provided to absorb impact transmitted from the road surface through the wheel 2 when the vehicle travels. In this case, the vehicle body B may be exemplified as a frame body or the like installed at the lower side of the vehicle and configured to reinforce the rigidity of the vehicle.

The suspension unit 400 may include the suspension arm 410 and the shock absorber 420.

The suspension arm 410 is provided between the second knuckle 320 and the vehicle body B and supports the second knuckle 320. More specifically, the suspension arm 410 connects the wheel 2 to the vehicle body B by means of the second knuckle 320 and absorbs a load applied from the wheel 2 by using rigidity thereof while the vehicle travels. Further, the suspension arm 410 serves to adjust a motion of the wheel 2.

The suspension arm 410 may include the first arm 411 and the second arm 412.

One end of the first arm 411 and one end of the second arm 412 may be rotatably connected to the second knuckle 320, and the other end of the first arm 411 and the other end of the second arm 412 are rotatably connected to the vehicle body B. In this case, the two opposite ends of each of the first arm 411 and the second arm 412 may be respectively rotatably supported on the second knuckle 320 and the vehicle body B by means of bushings, ball joints, pins, or the like. The first arm 411 and the second arm 412 may be disposed to face each other and be spaced apart from each other in an upward/downward direction. That is, one end of the first arm 411 and one end of the second arm 412 may be respectively connected to the upper and lower ends of the second knuckle 320. The first arm 411 and the second arm 412 may each be formed to have a double wishbone shape. Therefore, the first arm 411 and the second arm 412 may set a negative camber of the wheel 2, which makes it possible to improve the cornering performance of the vehicle and set a low-height structure for reducing a vehicle height.

The shock absorber 420 is provided to be extendable and contractible in a longitudinal direction and absorbs impact or vibration transmitted to the vehicle body through the wheel 2 from the road surface.

The shock absorber 420 may include the cylinder 421, the rod 422, and the elastic body 423.

The cylinder 421 may extend in the height direction of the vehicle body B, and the interior of the cylinder 421 may be filled with a damping fluid. The upper end of the cylinder 421 may penetrate the first arm 411, and the lower end of the cylinder 421 may be rotatably connected to the upper surface of the second arm 412.

The rod 422 may extend in the longitudinal direction of the cylinder 421, i.e., the height direction of the vehicle body B and installed to be slidable in the longitudinal direction of the cylinder 421. A lower end of the rod 422 may be inserted into an upper end of the cylinder 421, and an upper end of the rod 422 may be coupled to the wheel housing (not illustrated) or the like. The rod 422 may slide in the longitudinal direction of the cylinder 421 in conjunction with the rotation of the second arm 412 made by the bump or rebound motion of the wheel 2.

The elastic body 423 may be provided in the form of a flat spring having a longitudinal direction extending in a direction parallel to the width direction of the vehicle body B. The lower surface of the elastic body 423 may be seated on and supported on the upper surface of the second arm 412. One end of the elastic body 423 may be fixed to the vehicle body B by welding, bolting, or the like. When the second arm 412 is rotated by a bump or rebound motion of the wheel 2, the elastic body 423 may be elastically deformed in the upward/downward direction, thereby cancelling out impact applied from the road surface.

The steering drive unit 500 is disposed to be spaced apart from the knuckle unit 300 and generates the steering force for steering the wheel 2. The steering drive unit 500 may be coupled to and supported on the vehicle body B. Therefore, the steering drive unit 500 may reduce a magnitude of unsprung mass applied to the suspension unit 400, thereby further improving the ground contact performance of the vehicle.

The steering drive unit 500 may include a steering motor 540 and a control module 550.

The steering motor 540 may be exemplified as various types of electric motors each coupled to the vehicle body B and configured to generate a rotational force by receiving electric power from the battery (not illustrated) of the vehicle. The steering motor 540 may be integrally coupled to the vehicle body B by welding or the like. Alternatively, the steering motor 540 may be detachably coupled to the vehicle body B by bolting or the like.

The control module 550 is electrically connected to the steering motor 540 and controls an operation of the steering motor 540 in response to a steering signal generated when a driver manipulates a steering wheel (not illustrated). The control module 550 may include an electronic control unit (ECU), a central processing unit (CPU), a processor, or a system on chip (SoC). The control module 550 may control a plurality of hardware or software constituent elements by operating an operating system or an application and perform various types of data processing and computation. In addition, the control module 550 may include a memory configured to store various types of data processed and computed data. The memory may include at least one of non-volatile memory elements such as a read-only memory (ROM), a programmable ROM (PROM), an erasable programmable ROM (EPROM), an electrically erasable programmable ROM (EEPROM), and a flash memory, volatile memory elements such as a random access memory (RAM), and storage media such as a hard disc drive (HDD) or a CD-ROM.

The steering angle adjustment unit 600 is connected to the knuckle unit 300 and the steering drive unit 500 and adjusts the steering angle of the wheel 2 in conjunction with the steering force generated from the steering drive unit 500. That is, the steering angle adjustment unit 600 may be indirectly connected to the steering drive unit 500 by means of the power transmission unit 800.

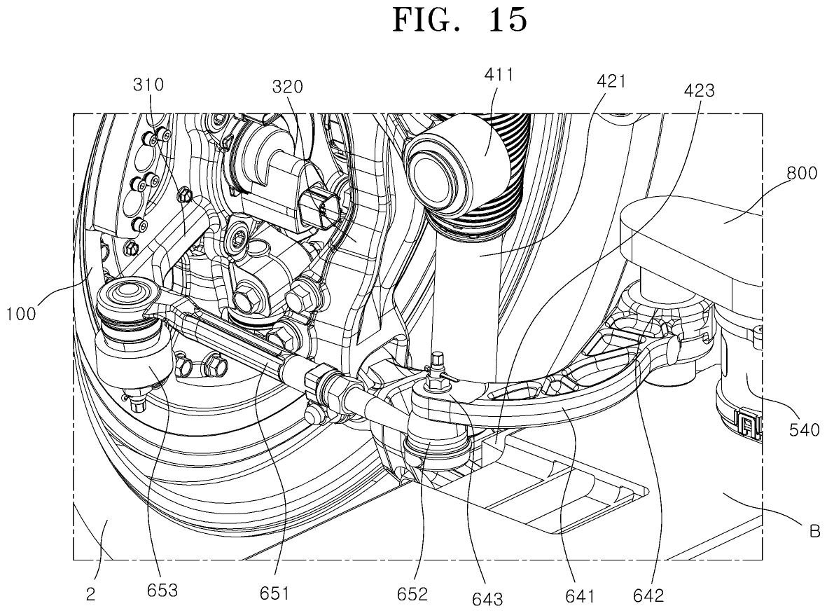

FIG. 15 is an enlarged view schematically illustrating a configuration of the steering angle adjustment unit according to the second embodiment of the present disclosure.

With reference to FIGS. 10 to 15, the steering angle adjustment unit 600 may include a first steering angle adjustment member 640 and a second steering angle adjustment member 650.

The first steering angle adjustment member 640 defines an external appearance of one side of the steering angle adjustment unit 600 and is connected to the power transmission unit 800 to be described below. The first steering angle adjustment member 640 reciprocates the second steering angle adjustment member 650, which will be described below, while rotating by receiving the steering force from the power transmission unit 800.

The first steering angle adjustment member 640 includes a link body 641, a first connection part 642, and a second connection part 643.

The link body 641 defines a schematic external appearance of the first steering angle adjustment member 640. The link body 641 may be formed to have an approximately rod shape and disposed so that two opposite sides thereof respectively face the power transmission unit 800 and the second steering angle adjustment member 650. The link body 641 may be disposed so that the longitudinal direction thereof is parallel to the longitudinal direction of the vehicle body B when the vehicle travels straight. When the steering drive unit 500 operates, the link body 641 may rotate clockwise or counterclockwise about the first connection part 642 disposed at one side. The link body 641 may reciprocate the second steering angle adjustment member 650 by applying a compressive or tensile load to the second steering angle adjustment member 650 through the second connection part 643 disposed at the other side depending on the rotation direction.

The first connection part 642 is disposed at one side of the link body 641 and connected to the power transmission unit 800. The first connection part 642 may be provided in the form of a hole formed through one end of the link body 641. The first connection part 642 may be disposed so that a central axis thereof is parallel to the height direction of the vehicle body B. A steering output shaft 830 of the power transmission unit 800 is inserted into the first connection part 642. An inner peripheral surface of the first connection part 642 may be integrally fixed to an outer peripheral surface of the steering output shaft 830 by welding, spline coupled, or the like. When the steering output shaft 830 rotates, the first connection part 642 may rotate the link body 641 clockwise or counterclockwise at the same angular velocity as the steering output shaft 830.

The second connection part 643 is disposed at the other side of the link body 641 and connected to the second steering angle adjustment member 650. The second connection part 643 may be provided in the form of a hole formed through the other end of the link body 641. The second connection part 643 may be disposed so that a central axis thereof is parallel to the height direction of the vehicle body B and the central axis of the first connection part 642. A first joint 652 of the second steering angle adjustment member 650 may be inserted into the first connection part 642. The first connection part 642 may be connected to the first joint 652 by welding, bolting, spline coupled, or the like. When the link body 641 rotates, the first connection part 642 may apply a compressive or tensile load to the second steering angle adjustment member 650 while rotating at the same angular velocity as the link body 641.

The second steering angle adjustment member 650 defines an external appearance of the other side of the steering angle adjustment unit 600 and is connected to the first steering angle adjustment member 640 and the knuckle unit 300. The second steering angle adjustment member 650 adjusts the steering angle of the wheel 2 by converting a rotational motion of the first steering angle adjustment member 640 into a straight reciprocating motion. The first steering angle adjustment member 640 and the second steering angle adjustment member 650 may be disposed so that the longitudinal directions thereof are inclined with respect to each other. Therefore, the first steering angle adjustment member 640 and the second steering angle adjustment member 650 may reduce a volume of a structure for transmitting the steering force, which is generated from the steering drive unit 500, to the knuckle unit 300, such that the interior space of the vehicle may be easily ensured, and a degree of design freedom of a life module may be increased.

The second steering angle adjustment member 650 may include a tie rod 651, the first joint 652, and a second joint 653.

The tie rod 651 defines a schematic external appearance of the second steering angle adjustment member 650 and supports the first joint 652 and the second joint 653, as a whole, which will be described below. The tie rod 651 may be provided in the form of a rod disposed so that two opposite sides thereof respectively face the knuckle unit 300 and the first steering angle adjustment member 640. The tie rod 651 may be disposed so that the longitudinal direction thereof is parallel to the width direction of the vehicle body B. The tie rod 651 is reciprocated in the width direction of the vehicle body B by a tensile or compressive load transmitted from the first steering angle adjustment member 640 through the first joint 652. The tie rod 651 changes the steering angle of the wheel 2 by pushing or pulling the knuckle unit 300 by means of the second joint 653 depending on the movement direction.

The first joint 652 is disposed at one side of the tie rod 651 and supports the tie rod 651 on the first steering angle adjustment member 640 so that the tie rod 651 is rotatable. The first joint 652 may be installed at one end of the tie rod 651 that faces the first steering angle adjustment member 640. One side of the first joint 652 may be integrally coupled to the tie rod 651 by welding or the like. Alternatively, one side of the first joint 652 may be detachably connected to the tie rod 651 by bolting or the like. The other side of the first joint 652 may be connected to the second connection part 643. When the link body 641 rotates, the first joint 652 applies a tensile or compressive load to the tie rod 651 while moving together with the second connection part 643.

The first joint 652 may support one side of the tie rod 651 on the second connection part 643 so that one side of the tie rod 651 is rotatable. Therefore, the first joint 652 may allow a rotational motion of the link body 641 to be smoothly converted into a straight reciprocating motion of the tie rod 651.

Furthermore, the first joint 652 may support the tie rod 651 on the second connection part 643 so that the tie rod 651 is rotatable about multiple axes. In this case, the first joint 652 may include various types of connection means such as ball joints, bushing joints, or the like that may support one side of the tie rod 651 on the second connection part 643 so that one side of the tie rod 651 is rotatable about multiple axes. Therefore, the first joint 652 may allow the tie rod 651 to perform the suspension motion while changing an installation angle of the tie rod 651 upward or downward with respect to the first steering angle adjustment member 640 when the wheel 2 performs a bump and rebound motion.

The second joint 653 is provided at the other side of the tie rod 651 and supports the tie rod 651 on the knuckle unit 300 so that the tie rod 651 is rotatable. The second joint 653 may be installed at the other end of the tie rod 651 that faces the knuckle unit 300. One side of the second joint 653 may be integrally coupled to the tie rod 651 by welding or the like. Alternatively, one side of the second joint 653 may be detachably connected to the tie rod 651 by bolting or the like. The other side of the second joint 653 may be connected to the knuckle unit 300, more specifically, the first knuckle 310. When the tie rod 651 reciprocates, the second joint 653 changes the steering angle of the wheel 2 while applying a tensile or compressive load to the first knuckle 310 while moving together with the tie rod 651. The second joint 653 is connected to the first knuckle 310 at a position spaced apart from the central axis of the wheel 2 at a predetermined interval in the radial direction of the wheel 2. Therefore, the second joint 653 may allow the rotational moment of force for generating the steering angle to be applied to the wheel 2 when the tie rod 651 reciprocates straight.

The second joint 653 may support the other side of the tie rod 651 on the first knuckle 310 so that the other side of the tie rod 651 is rotatable. Therefore, the first joint 652 may allow a rectilinear reciprocating motion of the tie rod 651 to be smoothly converted into a rotational motion of the first knuckle 310. Furthermore, the second joint 653 may support the tie rod 651 on the first knuckle 310 so that the tie rod 651 is rotatable about multiple axes. In this case, the second joint 653 may include various types of connection means such as ball joints, bushing joints, or the like that may support the other side of the tie rod 651 on the first knuckle 310 so that the other side of the tie rod 651 is rotatable about multiple axes. Therefore, the second joint 653 may allow the tie rod 651 to perform a suspension motion while changing an installation angle of the tie rod 651 upward or downward with respect to the first knuckle 310 when the wheel 2 performs a bump and rebound motion.

The power transmission unit 800 is provided between the steering drive unit 500 and the steering angle adjustment unit 600. The power transmission unit 800 amplifies the steering force generated from the steering drive unit 500 and transmits the steering force to the steering angle adjustment unit 600. That is, the power transmission unit 800 serves as a configuration for amplifying a magnitude of the steering force transmitted to the steering angle adjustment unit 600 by reducing a rotational speed of the steering motor 540 at a preset reduction ratio.

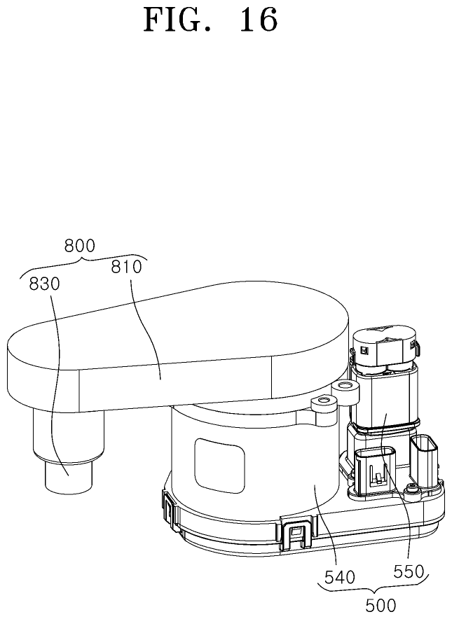

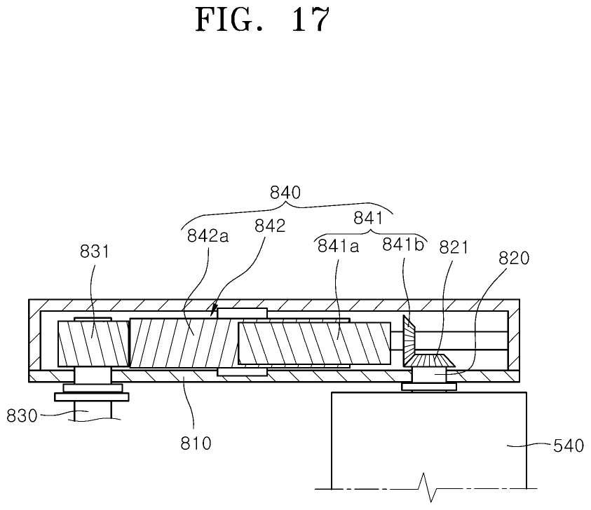

FIG. 16 is a perspective view schematically illustrating a configuration of the power transmission unit according to the second embodiment of the present disclosure, and FIG. 17 is a cross-sectional view schematically illustrating the configuration of the power transmission unit according to the second embodiment of the present disclosure.

With reference to FIGS. 16 and 17, the power transmission unit 800 may include a housing 810, a steering input shaft 820, the steering output shaft 830, and a transmission gear unit 840.

The housing 810 defines a schematic external appearance of the power transmission unit 800 and supports the steering input shaft 820, the steering output shaft 830, and the transmission gear unit 840 as a whole. The housing 810 is formed to have an empty space therein, and the steering input shaft 820, the steering output shaft 830, and the transmission gear unit 840 are accommodated in the housing 810. Therefore, the housing 810 may prevent the steering input shaft 820, the steering output shaft 830, and the transmission gear unit 840 from being damaged by external impact, foreign substances, or the like.

The housing 810 may be disposed at an upper side of the steering motor 540 and detachably coupled to the steering motor 540 by bolting or the like. The housing 810 may be openably and closably formed so that processes of replacing and managing the steering input shaft 820, the steering output shaft 830, and the transmission gear unit 840 installed in the housing 810 are easily performed. The specific shape of the housing 810 is not limited to the shape illustrated in FIG. 16. The shape of the housing 810 may be various designed and modified within the technical spirit as long as the housing 810 has a shape that may accommodate the steering input shaft 820, the steering output shaft 830, and the transmission gear unit 840 therein.

The steering input shaft 820 is connected to the steering drive unit 500 and rotates by receiving the steering force from the steering drive unit 500. The steering input shaft 820 may be provided in the form of a shaft having a predetermined length. The steering input shaft 820 may be disposed so that a longitudinal direction thereof is parallel to the height direction of the vehicle body B. A lower end of the steering input shaft 820 may protrude from a lower surface of the housing 810 and be connected to the rotor of the steering motor 540. When the steering motor 540 operates, the steering input shaft 820 may rotate clockwise or counterclockwise about the central axis. An upper end of the steering input shaft 820 may be disposed in the housing 810 and rotatably supported on the housing 810 by a bearing (not illustrated) or the like.

A first steering input gear 821 may be provided at an upper end of the steering input shaft 820 and transmit a rotational force to the transmission gear unit 840 to be described below. The first steering input gear 821 may be provided in the form of a bevel gear. However, the first steering input gear 821 is not limited to the above-mentioned shape. The first steering input gear 821 may be designed and modified as various types of gears or various types of power transmission means configured to engage with the transmission gear unit 840 and transmit the rotational force to the transmission gear unit 840.

The steering output shaft 830 may be disposed to be spaced apart from the steering input shaft 820 and connected to the steering angle adjustment unit 600. The steering output shaft 830 rotates the steering angle adjustment unit 600 in conjunction with the rotation of the steering input shaft 820.

The steering output shaft 830 may be provided in the form of a shaft having a predetermined length. The steering output shaft 830 may be disposed so that a longitudinal direction thereof is parallel to the height direction of the vehicle body B and parallel to the steering input shaft 820. A lower end of the steering output shaft 830 may protrude from the lower surface of the housing 810 and be rotatably connected to the upper surface of the vehicle body B. An upper end of the steering output shaft 830 may be disposed in the housing 810 and rotatably supported on the housing 810 by a bearing (not illustrated) or the like. When the steering drive unit 500 operates, the steering output shaft 830 rotates about the central axis by receiving the rotational force of the steering input shaft 820 through the transmission gear unit 840 to be described below. The steering output shaft 830 is penetratively inserted into the first connection part 642 of the steering angle adjustment unit 600. An outer peripheral surface of the steering output shaft 830 may be integrally fixed to an inner peripheral surface of the first connection part 642 by welding, spline coupled, or the like. Therefore, the steering output shaft 830 may rotate the steering angle adjustment unit 600 while rotating about the central axis.

A steering output gear 831 may be provided at the upper end of the steering output shaft 830 to receive the rotational force from the transmission gear unit 840 to be described below. The steering output gear 831 may be provided in the form of a helical gear. However, the steering output gear 831 is not limited to the above-mentioned shape. The steering output gear 831 may be designed and modified as various types of gear or power transmission means configured to engage with the transmission gear unit 840 and receive the rotational force from the transmission gear unit 840.

The transmission gear unit 840 is provided between the steering input shaft 820 and the steering output shaft 830 and transmits the rotational force, which is applied between the steering input shaft 820 and the steering output shaft 830, only in one direction. More specifically, the transmission gear unit 840 allows the rotational force of the steering input shaft 820, which is generated by the operation of the steering drive unit 500, to be transmitted to the steering output shaft 830. Further, the transmission gear unit 840 prevents the rotational force of the steering output shaft 830, which is generated by being reversely inputted through the wheel 2 from the road surface, from being transmitted to the steering input shaft 820. Therefore, the transmission gear unit 840 may prevent the steering angle adjustment unit 600 from being reversely rotated by a reaction force reversely inputted through the wheel 2 from the road surface at the time of steering the wheel 2, thereby improving the traveling and manipulating stability of the vehicle.

The transmission gear unit 840 may include a first transmission gear 841 and a second transmission gear 842.

The first transmission gear 841 is connected to the steering input shaft 820 and rotates in conjunction with the rotation of the steering input shaft 820. The first transmission gear 841 may be rotatably supported on the housing 810 by a bearing, shaft coupling, or the like.

The first transmission gear 841 may include a worm gear 841a having a worm screw thread formed on an outer peripheral surface thereof, and a second steering input gear 841b coupled by engaging with the first steering input gear 821.

The worm gear 841a and the second steering input gear 841b may be disposed so that central axes are perpendicular to the steering input shaft 820. The worm gear 841a and the second steering input gear 841b may be connected by a single rotary shaft and rotate at the same angular velocity. Alternatively, the worm gear 841a and the second steering input gear 841b may rotate at different angular velocities by additional gears.

The second transmission gear 842 is coupled by engaging with the first transmission gear 841 and rotates the steering output shaft 830 in conjunction with the rotation of the first transmission gear 841. The second transmission gear 842 may be rotatably supported on the housing 810 by a bearing, shaft coupling, or the like.

The second transmission gear 842 may include a worm wheel 842a having one side coupled by engaging with the worm gear 841a, and the other side coupled by engaging with the steering output gear 831. The worm wheel 842a may be disposed so that a central axis thereof is perpendicular to the worm gear 841a and the second steering input gear 841b and parallel to the steering input shaft 820 and the steering output shaft 830.

Hereinafter, an operation of the corner module apparatus 1′ for a vehicle according to the second embodiment of the present disclosure will be described in detail.

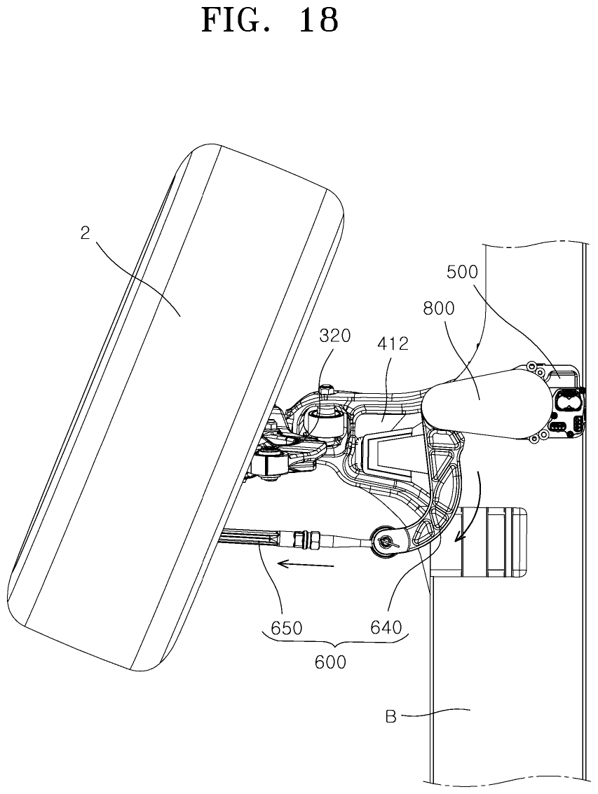

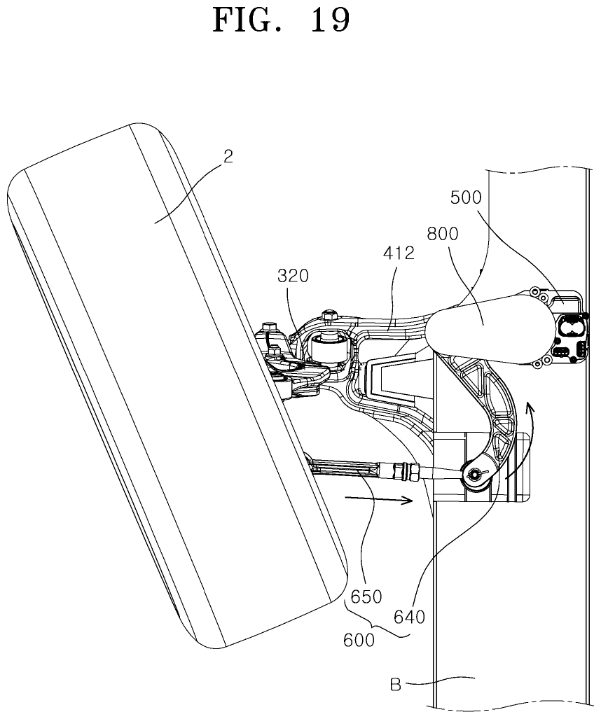

FIGS. 18 and 19 are operational views schematically illustrating an operation of the corner module apparatus for a vehicle according to the second embodiment of the present disclosure that adjusts the steering angle of the wheel.

With reference to FIG. 18, at the time of steering the vehicle rightward, the steering motor 540 generates a rotational force in one direction under the control of the control module 550.

The rotational force generated from the steering motor 540 is transmitted to the link body 641 sequentially through the steering input shaft 820, the first transmission gear 841, the second transmission gear 842, and the steering output shaft 830.

The link body 641 applies a compressive load in the longitudinal direction to the tie rod 651 while rotating clockwise (based on FIG. 18) about the first connection part 642.

The tie rod 651 is rectilinearly moved outward in the width direction of the vehicle by the compressive load.

When the tie rod 651 rectilinearly moves outward in the width direction of the vehicle, the second joint 653 finally presses the first knuckle 310 and rotates the wheel 2 rightward.

With reference to FIG. 19, at the time of steering the vehicle leftward, the steering motor 540 generates a rotational force in the other direction under the control of the control module 550.

The rotational force generated from the steering motor 540 is transmitted to the link body 641 sequentially through the steering input shaft 820, the first transmission gear 841, the second transmission gear 842, and the steering output shaft 830.

The link body 641 applies a tensile load in the longitudinal direction to the tie rod 651 while rotating counterclockwise (based on FIG. 19) about the first connection part 642.

The tie rod 651 is rectilinearly moved inward in the width direction of the vehicle by the tensile load.

When the tie rod 651 rectilinearly moves inward in the width direction of the vehicle, the second joint 653 finally pulls the first knuckle 310 and rotates the wheel 2 leftward.

Meanwhile, at the time of steering the wheel 2, a steering reaction force may be reversely inputted in a direction in which the steering force of the wheel 2 is cancelled out by friction, vibration, or the like between the wheel 2 and the road surface.

The steering reaction force is transmitted to the second transmission gear 842 sequentially through the second steering angle adjustment member 650, the first steering angle adjustment member 640, and the steering output shaft 830.

The steering reaction force transmitted to the second transmission gear 842 is not transmitted to the first transmission gear 841 by the structure for coupling the worm gear 841a and the worm wheel 842a. Therefore, the second steering angle adjustment member 650, the first steering angle adjustment member 640, and the steering output shaft 830 may prevent a reverse rotation caused by the steering reaction force.

While the present disclosure has been described with reference to the embodiment illustrated in the drawings, the embodiment is only for illustrative purpose, and those skilled in the art to which the present technology pertains will understand that various modifications of the embodiment and any other embodiment equivalent thereto are available. Accordingly, the true technical protection scope of the present disclosure should be defined by the appended claims.

Although exemplary embodiments of the disclosure have been disclosed for illustrative purposes, those skilled in the art will appreciate that various modifications, additions and substitutions are possible, without departing from the scope and spirit of the disclosure as defined in the accompanying claims. Thus, the true technical scope of the disclosure should be defined by the following claims.

What is claimed is:

1. A corner module apparatus for a vehicle, comprising:
a drive unit configured to provide driving power to a wheel;
a knuckle unit connected to the drive unit;
a steering drive unit configured to couple to a vehicle body and configured to generate a steering force while extending or contracting in a longitudinal direction of the steering drive unit;
a steering angle adjustment unit connected to the knuckle unit, disposed so that a longitudinal direction of the steering angle adjustment unit is different from the longitudinal direction of the steering drive unit, and configured to adjust a steering angle of the wheel in conjunction with the steering force generated from the steering drive unit; and
a crank member disposed to be spaced apart from the steering drive unit in a height direction of the vehicle body and configured to convert a transmission direction of the steering force, which is generated from the steering drive unit, into the longitudinal direction of the steering angle adjustment unit.

2. The corner module apparatus of claim 1, wherein the steering drive unit comprises:
a power generation module configured to couple to the vehicle body and configured to generate driving power;
a push rod configured to be extended or retracted in conjunction with the driving power of the power generation module; and
a first joint extending from the push rod and rotatably connected to one side of the crank member.

3. The corner module apparatus of claim 2, wherein the wheel comprises front and rear wheels disposed to be spaced apart from each other in a longitudinal direction of the vehicle body, and the power generation module is configured to be disposed between the front and rear wheels.

4. The corner module apparatus of claim 2, wherein the push rod is disposed so that a longitudinal direction of the push rod is parallel to a longitudinal direction of the vehicle.

5. The corner module apparatus of claim 1, wherein the steering angle adjustment unit comprises:
a tie rod having one side and an other side opposing each other and face the crank member and the knuckle unit, respectively;
a second joint at the one side of the tie rod and rotatably connected to the other side of the crank member; and
a third joint at the other side of the tie rod and rotatably connected to the knuckle unit.

6. The corner module apparatus of claim 5, wherein the second joint is connected to the other side of the crank member so as to be rotatable about multiple axes.

7. The corner module apparatus of claim 1, wherein the crank member comprises:
a crank body supported to be rotatable about an axis defined in the height direction of the vehicle body;
a first extension part extending from the crank body and connected to the steering drive unit; and
a second extension part extending from the crank body and connected to the steering angle adjustment unit.

8. The corner module apparatus of claim 7, wherein the first and second extension parts extend in different directions from the crank body.

9. The corner module apparatus of claim 7, wherein a length of the first extension part is shorter than a length of the second extension part.

10. The corner module apparatus of claim 7, wherein when the steering drive unit performs an extension or contraction operation, the second extension part rotates at the same angular velocity as the first extension part and applies a compressive or tensile load to the steering angle adjustment unit depending on a rotation direction.

11. A corner module apparatus for a vehicle, comprising:
a drive unit configured to provide driving power to a wheel;
a knuckle unit connected to the drive unit;
a steering drive unit disposed to be spaced apart from the knuckle unit and configured to generate a steering force;
a steering angle adjustment unit connected to the knuckle unit and the steering drive unit and configured to adjust a steering angle of the wheel in conjunction with the steering force generated from the steering drive unit; and
a power transmission unit between the steering drive unit and the steering angle adjustment unit and configured to amplify the steering force generated from the steering drive unit and transmit the steering force to the steering angle adjustment unit.

12. The corner module apparatus of claim 11, wherein the steering drive unit comprises a steering motor configured to couple to a vehicle body and configured to generate a rotational force.

13. The corner module apparatus of claim 11, wherein the power transmission unit comprises:
a steering input shaft connected to the steering drive unit and configured to rotate by receiving the steering force from the steering drive unit;
a steering output shaft connected to the steering angle adjustment unit and configured to rotate the steering angle adjustment unit in conjunction with a rotation of the steering input shaft; and
a transmission gear unit between the steering input shaft and the steering output shaft and configured to allow transmission of a rotational force of the steering input shaft to the steering output shaft and block transmission of a rotational force of the steering output shaft to the steering input shaft.

14. The corner module apparatus of claim 13, wherein the transmission gear unit comprises:
a first transmission gear connected to the steering input shaft and configured to rotate in conjunction with the rotation of the steering input shaft; and
a second transmission gear coupled by engaging with the first transmission gear and configured to rotate the steering output shaft in conjunction with a rotation of the first transmission gear.

15. The corner module apparatus of claim 14, wherein the first transmission gear comprises a worm gear, and the second transmission gear comprises a worm wheel.

16. The corner module apparatus of claim 11, wherein the steering angle adjustment unit comprises:
a first steering angle adjustment member connected to the power transmission unit and configured to rotate by receiving the steering force from the power transmission unit; and
a second steering angle adjustment member connected to the first steering angle adjustment member and the knuckle unit and configured to adjust the steering angle of the wheel by converting a rotational motion of the first steering angle adjustment member into a straight reciprocating motion.

17. The corner module apparatus of claim 16, wherein the first steering angle adjustment member comprises:
a link body having one side and an other side opposing each other and face the power transmission unit and the second steering angle adjustment member, respectively;
a first connection part disposed at the one side of the link body and connected to the power transmission unit; and
a second connection part disposed at the other side of the link body and connected to the second steering angle adjustment member.

18. The corner module apparatus of claim 17, wherein the link body rotates about the first connection part and applies a compressive or tensile load to the second steering angle adjustment member depending on a rotation direction.

19. The corner module apparatus of claim 16, wherein the second steering angle adjustment member comprises:
a tie rod having one side and an other side opposing each other and face the knuckle unit and the first steering angle adjustment member, respectively;
a first joint disposed at the other side of the tie rod and configured to support the tie rod on the first steering angle adjustment member so that the tie rod is rotatable; and
a second joint disposed at the one side of the tie rod and configured to support the tie rod on the knuckle unit so that the tie rod is rotatable.

20. The corner module apparatus of claim 19, wherein the first and second joints support the other side and the one side of the tie rod on the first steering angle adjustment member and the knuckle unit so that the other side and the one side of the tie rod are rotatable about multiple axes.
